(19) United States
(12) Patent Application Publication
(10) Pub. No.: US 2026/0346951 A1
(43) Pub. Date: Nov. 5, 2026

(54) POWER-SPLIT HYBRID DRIVELINE FOR AN ELECTRIC BICYCLE TO ALLOW ASSISTANCE POWER TO BE SWITCHED OFF

(71) Applicant: RAICAM DRIVELINE S.R.L., Mondovi' (Cuneo) (IT)

(72) Inventors: Benjamin Chetwood STRUVE', Kenilworth, Warwickshire (GB); Sandro BONARDO, Peveragno (Cuneo) (IT); Andrea CANESTRARI, San Costanzo (Pesaro Urbino) (IT)

(73) Assignee: RAICAM DRIVELINE S.R.L., Mondovi' (Cuneo) (IT)

(21) Appl. No.: 19/109,182

(22) PCT Filed: Sep. 7, 2023
(86) PCT No.: PCT/IB2023/058841

§ 371 Date: Mar. 6, 2025

(30) Foreign Application Priority Data
Sep. 8, 2022 (IT) 102022000018321

(51) Int. Cl. B62M 11/18; B62M 6/55

(52) U.S. Cl. CPC B62M 11/18; B62M 6/55

(57) ABSTRACT

An electric auxiliary drive system for a bicycle has a pedal crankshaft, an epicyclic gearing mechanism, an assist motor for driving an output shaft, and a control motor for controlling, through the epicyclic gearing mechanism, a transmission ratio between the pedal crankshaft and the output shaft. The epicyclic gearing mechanism has a first sun gear and a second sun gear, both secured for rotation with the output shaft. A planet carrier is secured for rotation with the pedal crankshaft and supports a first set of planet gears between the first sun gear and a first ring gear, and a second set of planet gears between the second sun gear and a second ring gear. A locking device blocks rotation of the second ring gear, allowing a rider to push the bicycle beyond a pre-set speed limit, without being assisted electrically, while still pedalling at a comfortable pedal rotation speed.

### TECHNICAL FIELD

The present invention pertains to the field of electrically powered bicycles (or “e-bikes”) with an electric motor assisting the rider's pedal-power. More specifically, the present invention concerns an e-bike Power-split hybrid driveline for an electric bicycle to allow assistance power to be switched off.

### BACKGROUND TO THE INVENTION

Power-split hybrid drivelines have been recently proposed for electric bicycles. Some of these systems include a pedal crankshaft for operation by a rider, an epicyclic gearing mechanism, an assist motor and a control motor. The epicyclic gearing mechanism is arranged to determine the transmission ratio between the pedal crankshaft and an output shaft for transmitting rotation to a rear wheel of the bicycle. The epicyclic gearing mechanism is referred to as an epicyclic “power-split” gearing mechanism, because it is arranged to transfer power from the pedals to the rear wheel of the bicycle through two routes: a mechanical route and an electrical route. Specifically, the epicyclic gearing mechanism transmits power from the assist motor to the output shaft. Furthermore, the epicyclic gearing mechanism adjusts the rotational speed of the pedal crankshaft as a result of the operation of control motor.

The epicyclic hybrid driveline of the present disclosure pertains to so-called “12” epicyclic driveline layouts for e-bikes. In such a layout, where the pedals are connected to a planetary carrier, a chain ring for driving the rear wheel is connected to a sun gear that is assisted by a traction motor or assist motor. A ratio controlling motor is connected to a ring gear of the epicyclic gearing system for controlling the transmission ratio between the pedal crankshaft and the output shaft. As the speed of the bicycle increases, the ratio controlling motor assist increases the overall gear ratio value in order that the rotational speed of the pedals (i.e. the rotational speed of the pedal shaft) be maintained at a speed which is comfortable for the rider.

One of the most recent power-split hybrid drivelines for an electric bicycle (Italian Patent application No. 102022000009794 filed on 12 May 2022, to the same Applicant, and not yet available to the public at the filing date of this application), provides an electric auxiliary drive system which comprises a pedal crankshaft, an epicyclic gearing mechanism, an assist motor for driving an output shaft, and a control motor for controlling, through the epicyclic gearing mechanism, the transmission ratio between the pedal crankshaft and the output shaft.

A first one-way clutch, operatively connected to the control motor, is configured for blocking the rotation of a ring gear of the epicyclic gearing system in a forward direction of rotation while allowing its free rotation in the reverse direction of rotation. A second one-way clutch is configured for drivingly connecting the assist motor to the output shaft when the assist motor is switched on, and for disengaging the assist motor from the output shaft when the assist motor is switched off but the output shaft continues rotation in the forward direction.

In the above-mentioned drive system, a pedal shaft is driving a planetary carrier having planets that are engaged by the outer ring gear, which is driven by the ratio controlling motor. A sun gear is connected to the chain gear and a traction gear which is secured for rotation with the chain gear and the planetary carrier. The chain gear is driven by traction motor M2. A one-way clutch is associated with the ratio controlling motor, so that the ring gear may only turn in one direction. The transmission ratio between the pedal crankshaft and the output shaft is determined by the gears of the epicyclic system. When the rider starts pedalling at low speed, the planets are pushing against the ring gear, which is locked in position by the one-way clutch and therefore provides the lowest transmission ratio. As the speed of the bicycle increases, the ratio controlling motor starts to spin, and the ring gear is rotated backwards, which slows down the pedals through the planets, relatively to the sun gear, so that the bicycle can keep a comfortable transmission ratio.

The European legislation (European standard EN 15194:2017 for Electrically power assisted cycles) demands that the electrical assistance is switched off above a certain road speed (25 km/h), in order to limit the potential velocity of the bicycle and to reduce the safety risk involved with riding this type of vehicle.

A limit encountered with the some of the current I2 epicyclic drivelines is that the biker is not allowed to comfortably push the bicycle pedalling beyond a pre-set limit speed, namely 25 km/h, at which the assistance of the electric motor(s) is automatically cut off. With current I2 layouts the torque from the pedals is always reacted against the ratio controlling motor. As the road speed of the bicycle rises, the ratio controlling motor increases in velocity in order to maintain a comfortable pedalling speed for the rider. Hence the ratio controlling motor supplies considerable mechanical power to the system which contributes to assisting the forward motion of the bicycle. If the ratio controlling motor is switched off, in order to comply with the legislative requirement to remove electrical assistance, the motor torque which counteracts the rider's pedalling is removed. Hence the bicycle pedals spin freely which makes it impossible for the rider to continue pedalling.

### SUMMARY OF THE INVENTION

It is an object of the present invention to allow the rider to push the bicycle beyond a pre-set speed limit (for example 25 km/h), relying only on his/her mechanical physical power, without being assisted electrically, while still pedalling at a comfortable speed of rotation of the pedals.

Against the foregoing background, the present invention provides an electric auxiliary drive system for a bicycle, having the features defined in claim 1. Preferred embodiments are defined in the dependent claims.

According to an aspect, the present invention provides an electric auxiliary drive system for a bicycle, comprising:
a pedal crankshaft for operation by a rider;
an output shaft for transmitting rotation to a rear wheel of the bicycle;

an epicyclic gearing mechanism arranged to determine a transmission ratio between the pedal crankshaft and the output shaft;
an assist motor for driving the output shaft;
a control motor, drivingly connected to the epicyclic gearing mechanism for controlling, through the epicyclic gearing mechanism, the transmission ratio between the pedal crankshaft and the output shaft. At least one first one-way clutch is operatively connected between the control motor and a rigid element fixedly mountable to the bicycle frame, wherein the first one-way clutch is configured for blocking the rotation of a first ring gear of the epicyclic gearing system in a first, forward direction of rotation and for releasing and allowing free rotation of said first ring gear of the epicyclic gearing system in a second, reverse direction of rotation. A second one-way clutch is operatively connected between the assist motor and the output shaft, wherein the second one-way clutch is configured for drivingly connecting the assist motor to the output shaft when the assist motor is switched on to drive the output shaft in a forwards direction, so as to assist in driving the bicycle forwards, and for disengaging the assist motor from the output shaft when the assist motor is switched off but the output shaft continues rotation in the forward direction. The epicyclic gearing mechanism further comprises:
a second ring gear and an associated locking device fixedly mountable to a bicycle frame and operable to engage and block the rotation of the second ring gear;
a first and a second sun gear, both secured for rotation with the output shaft;
a first set of planet gears between the first sun gear and the first ring gear, and a second set of planet gears between the second sun gear and the second ring gear, and
a planet carrier which is secured for rotation with the pedal crankshaft and supports the first and the second sets of planet gears. The first and second sun gears and the first and second sets of planet gears are configured to provide a desired transmission ratio between the pedal crankshaft and the output shaft for transmitting rotation to a rear wheel of the bicycle when the rotation of the second ring gear is locked by the locking device.

According to another aspect, the present invention provides an electrically powered bicycle comprising a drive system as defined in the appended claims.

### BRIEF DESCRIPTION OF THE DRAWINGS

In order that the present invention may be well understood there will now be described a few preferred embodiments thereof, given by way of example, reference being made to the accompanying drawings, in which:

FIG. 1 is a schematic cross-sectional view of the main components of an e-bike drive system according to an embodiment of the present invention;

FIG. 2 diagrammatically shows the torque split relationship through the epicyclic gear mechanism;

FIGS. 3 to 6 schematically depict the power flow within the system during different stages of bicycle acceleration; and

FIG. 7 is a schematic cross-sectional view of the main components of an e-bike drive system according to an alternative embodiment of the present invention.

### DETAILED DESCRIPTION

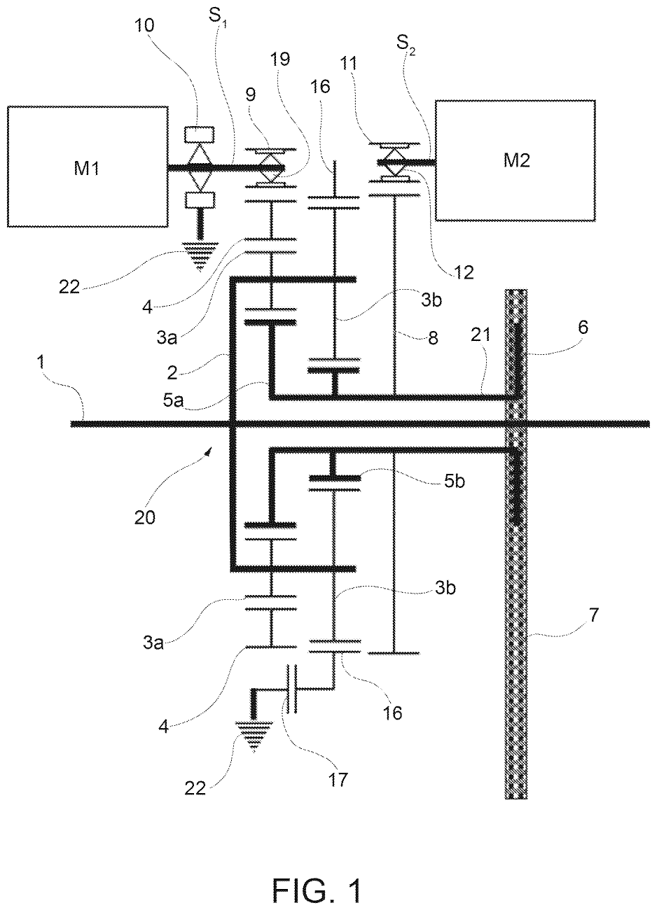

Referring initially to FIG. 1, an e-bike drive system comprises two electric motors, M1, M2, and an epicyclic gearing mechanism 20 having an output shaft 21. Secured for rotation with the output shaft 21 is a chain ring 6 that drives the rear wheel (not shown) of the bicycle.

Designated at 1 is a pedal shaft or crankshaft for operation by a rider R. The pedal shaft 1 passes through the assembly and connects together two conventional pedal crank and foot support assemblies (not illustrated in the drawings) which are mounted outside the drive unit. The pedal shaft 1 takes the torque and speed supplied by the rider and transfers it to the planetary carrier 2.

Electric motor M1 is termed “control” motor, or “ratio controlling” motor, because it drives a gear of the epicyclic gearing mechanism that controls the transmission ratio between the output shaft and the pedal crankshaft.

Electric motor M2, termed “assist” motor (or “traction” motor) herein, generates power that is transmitted to the output shaft 21 for moving the e-bike forwards.

In this context, the epicyclic gearing mechanism is also referred to as an epicyclic “power-split” gearing mechanism, because it is arranged to transfer power from the pedals to the rear wheel of the bicycle through two routes, as explained herein after: a mechanical route MR and an electrical route ER. Specifically, the assist motor M2 transmits power to the output shaft. Furthermore, the epicyclic gearing mechanism adjusts the rotational speed of the pedal crankshaft 1 as a result of the operation of control motor M1.

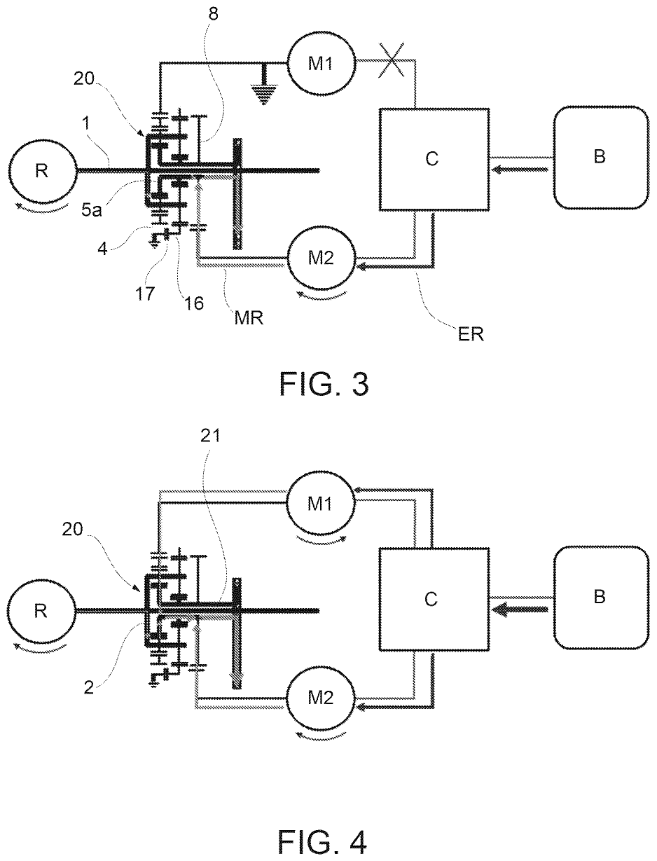

The e-bike drive system is to be accommodated in a housing (not shown in the drawings), preferably mounted in use centrally within the frame of a bicycle (at the ‘bottom bracket’). Typically, the housing provides mountings and reaction points with rolling bearings rotatably supporting the pedal crankshaft 1. The housing may also contain an electronic controller C (shown in FIG. 3) for the drive system.

The epicyclic gearing mechanism 20 comprises a planetary carrier 2 which supports two sets of planet gears, namely a first set of planet gears 3a and a second, supplementary set of planet gears 3b, and applies the rider's torque and speed to the epicyclic gear system.

The planetary carrier 2 is secured for rotation with the pedal shaft 1. The pedal shaft 1 takes the torque and speed supplied by the rider and transfers it to the planetary carrier 2.

The power split epicyclic gearing mechanism comprises a first sun gear 5a and a second sun gear 5b which are both integral with the chain ring 6 and the output shaft 21. The first sun gear 5a and the second sun gear 5b may both be driven for rotation by the assist motor M2 through a traction gear 8 which is secured for rotation with the sun gears 5a, 5b and the chain ring 6.

The first sun gear 5a has external teeth which mesh with the first set of planet gears 3a. The second sun gear 5b has external teeth which mesh with the second set of planet gears 3b.

As explained in the following, according to a preferred embodiment, as in the example illustrated in FIG. 1, the first set of planet gears 3a may be smaller, i.e. have a smaller diameter, than the second, supplementary set of planet gears 3b.

According to the exemplary embodiment illustrated in FIG. 1, the first sun gear 5a has a larger diameter than the second sun gear 5b.

A first ring gear 4 has internal teeth which mesh with the first set of planet gears 3a, and external teeth which mesh with a pinion gear 9 driven directly by the ratio controlling motor M1.

The planet gears 3a of the first set are free to rotate relative to the planetary carrier 2 and hence apply an equal tangential force to the first ring gear 4 and the first sun gear 5a, regardless of the relative speeds of these components. Hence, a fixed proportion of the torque from the rider is distributed to the ring gear 4 and the remaining proportion of the torque from the rider is distributed to the sun gear Sa.

A second ring gear 16 has internal teeth which mesh with the second set of planet gears 3b.

According to the exemplary embodiment of FIG. 1, the planet gears 3b of the second set may be supported around the same axes and at the same radius as the planet gears 3a.

Optionally, according to alternative embodiments (not illustrated), the planet gears 3b of the second set may be mounted to the planet carrier 2 by a separate set of mounting pins which are mounted at a different radius. Hence, there need not be a fixed relationship between the geometry of the epicyclic gear subsystem comprising components 3a, 4 and 5a, and the epicyclic gear subsystem comprising components 3b, 5b and 16.

A locking device 17 is mounted to the bicycle frame 22 or a rigid element fixedly secured thereto. The locking device 17 is operable to engage and stop the second ring gear 16 from rotating. For example, the locking device 17 may be made as an electromagnetic operated clutch as an electromagnetic pin that may be extended to or engage a corresponding locking seat, such as an opening or a recess, formed in the second ring gear 16.

The output shaft 21 may be a hollow tubular shaft through which the pedal shaft 1 passes.

The chain sprocket or belt sprocket 6 drives either a chain or a toothed belt 7 which drives the rear wheel of the bicycle.

The traction gear 8 has outer teeth which mesh with a second pinion gear 11 driven directly by the assist motor M2.

A first one-way clutch 10 may be arranged to releasably connect a shaft S1 of the ratio controlling motor M1 to a rigid element 22 fixedly secured to or integral with the bicycle frame, Preferably, the rigid, fixed element 22 may be a housing of the drive unit.

The purpose of the first one-way clutch 10 to block the rotation of first ring gear 4 in the forward direction (i.e. the forward direction being the direction of rotation of the pedals, the chain and the wheels of the bicycle when it is moving forwards), but to allow free rotation of the first ring gear 4 in the reverse direction.

A supplementary one-way clutch 19 may be arranged between the pinion gear 9 and the shaft S1 of control motor M1.

The purpose of the supplementary one-way clutch 19 is to lock the rotation of the first ring gear 4 when the control motor M1 is attempting to drive the first ring gear 4 in the reverse direction, so as to counteract the rider torque which is applied to the first ring gear 4. As explained herein after, the supplementary one-way clutch 19 allows free rotation of the first ring gear 4 when the control motor M1 is switched off but the first ring gear continues rotating in the reverse direction.

The second pinion gear 11 is connected to a shaft S2 of the assist motor M2 via a second one-way clutch 12. The second pinion gear 11 meshes with the traction gear 8 so that assist motor M2 can assist in driving the bicycle forwards.

The second one-way clutch 12 that connects assist motor M2 with its pinion gear 11 is arranged so that it is engaged when the assist motor M2 is attempting to drive the traction gear 8 in the forward direction, so as to assist in driving the bicycle forwards. The second one-way clutch 12 allows free rotation of the traction gear 8 when the assist motor M2 is switched off but the traction gear rotation continues to rotate in the forward direction.

The one-way clutches 10, 12, 19 may be, for example, in the form of a pawl and ratchet, or a sprag clutch with rollers which ride up ramps within a cage, or a belt or strap which is wrapped around a shaft.

Due to the above arrangement, control motor M1, by controlling the speed of the first ring gear 4, controls the ratio between the speed of the pedals and the speed of the bicycle. Assist motor M2, by driving the traction gear 8, applies torque to the chain gear 6 and assists in moving the bicycle forwards.

The above described e-bike drive system functions in the following way. When the bicycle is starting from rest, the rider applies torque to the system via the pedals. This torque is transferred into the system via the pedal shaft 1, planetary carrier 2 and to the planet gears 3a. The planet gears then distribute this applied torque between the first ring gear 4 and the sun gear 5a.

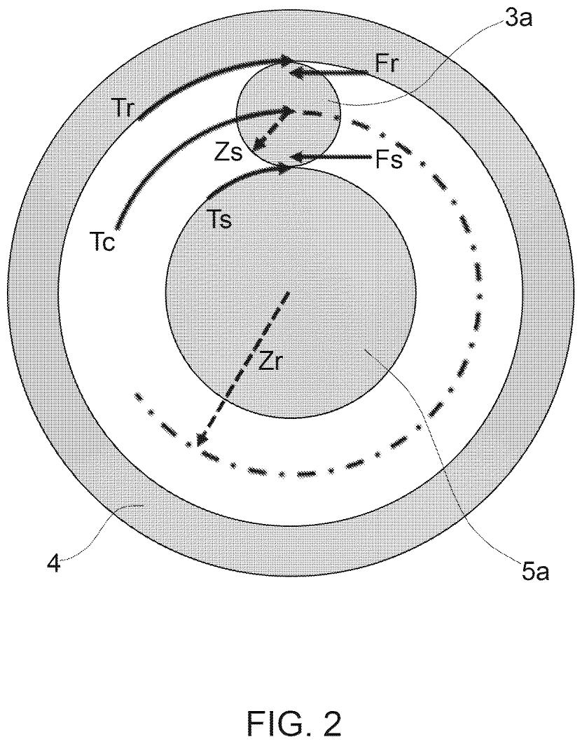

The distribution of torque between the ring gear and the sun gear is schematically shown in FIG. 2, wherein:
Tc=torque applied to the planetary carrier 2;
Zr=radius of the planetary carrier 2;
Zs=radius of the planetary gears 3a;
Fr=tangential force applied to the first ring gear 4;
Fs=tangential force applied to the sun gears 5a;
and wherein Fr=Fs=½*Tc/Zr
Tr=torque applied to the ring gear: Tr=Fr*(Zr+Zs); and
Ts=torque applied to the sun gears: Ts=Fs*(Zr−Zs)

Initially, starting from rest (FIG. 3), the control motor M1 is switched off. The torque Tr is applied to the first ring gear 4 in a forward direction, however the first one-way clutch 10 is arranged to block the forwards rotation of the first ring gear 4. Hence the torque Tr is reacted by the first one-way clutch 10 and the first ring gear 4 remains stationary. All of the power supplied by the rider R is hence diverted to the sun gear 5a and via the chain gear 6 and the chain or belt 7, to the bicycle wheel. The gear ratio between the pedals and the wheel of the bicycle is expressed as follows:

$$overall gear ratio = \frac{Rotation speed of bicycle wheel}{Rotation speed of the pedals}$$

Due to the action of the first one-way clutch 10, which allows rotation of the first ring gear 4 in the reverse direction but does not allow rotation in the forwards direction, the lowest overall gear ratio exists when the first ring gear 4 is stationary. The ratios of the epicyclic gear system and the chain or belt ratio may be arranged so that the ratio with the first ring gear stationary equates to a suitable ratio for starting the bicycle from rest or climbing a steep hill. By way of indication, this lowest ratio may have a numerical value of approximately 1:1 for a touring or commuter bicycle, meaning that one turn of the pedals gives about 1 turn of the rear wheel. This transmission ratio is achieved by setting the number of teeth and diameters of the gears in the epicyclic system.

During the starting from rest (FIG. 3), the traction motor M2 may be energised by the battery B through the controller C in order to provide assistance to the rider in moving the bicycle forwards. The traction motor M2 applies torque via the second one-way clutch 12 and the pinion gear 11 to move the traction gear 8 in a forward direction and hence assist with the forward acceleration of the bicycle. The second one-way clutch 12 is arranged so that it is locked when the traction motor M2 is applying torque to the traction gear 8 in the forward direction.

As the bicycle starts to increase its speed, there is the requirement for the overall gear ratio value to increase, in order that the rotational speed of the pedals (i.e. the rotational speed of the pedal shaft 1) be maintained at a speed which is comfortable for the rider. This is achieved by energising the control motor M1 (FIG. 4) in order to rotate the ring gear 4 in the reverse direction. This action unlocks the first one-way clutch 10, which is arranged to allow free rotation of the ring gear 4 in reverse. The speed of control motor M1 is controlled in order to maintain the desired ring gear speed (Wr) which is given by the following equation:

Wr=(Wc(Zr+Zs)−Ws×Zs)/Zr
where:
Wc=desired rotational speed of pedal shaft 1;
Ws=rotational speed of sun gear 5;
Wr=consequently required speed of ring gear 4;
Zr and Zs are the system radii which define the lever ratios within the epicyclic gear system, as described graphically in FIG. 2.

Complying with the law of conservation of energy the mechanical power supplied by control motor M1 supplements the mechanical power supplied by traction motor M2 in assisting the rider to move the bicycle forwards.

As the speed of control motor M1 starts to increase, in order to maintain a comfortable pedalling speed, it starts to supply mechanical power to the system:

Power_{M1}=Wr*Tr

Where Tr is the torque applied to the ring gear 4 in order to react against the pedalling torque of the rider (as illustrated in FIG. 2).

The locking device 17 continues to be not energised so that the second ring gear 16 is free to rotate, and no torque is transmitted through the planets to the supplementary sun gear 5b. However, due to the reverse rotation of the first ring gear 4, the difference in speed between the supplementary sun gear 5b and the planetary carrier 2 is increased. Therefore, the second ring gear 16 continues to rotate forwards, but at a decreasing speed.

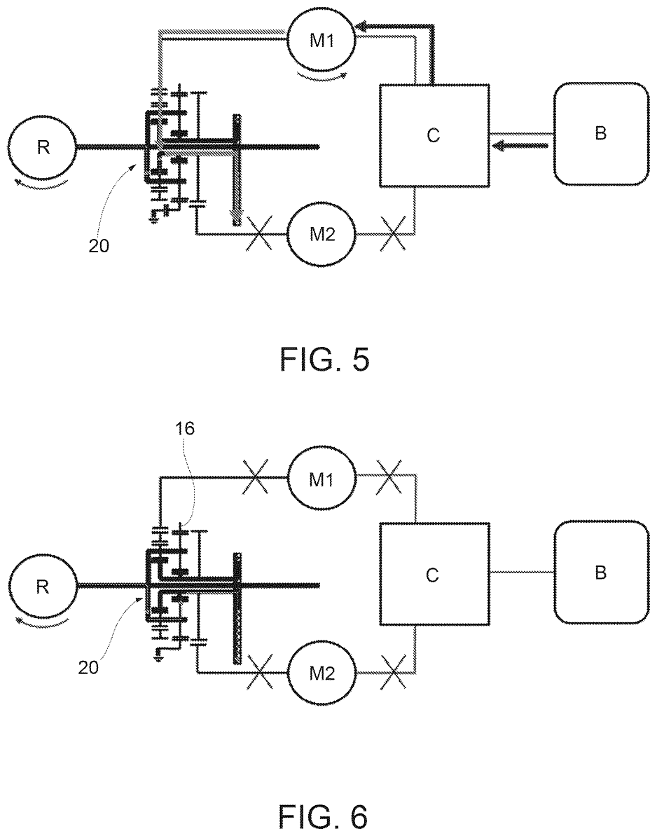

As the speed of the bicycle increases further, the torque Tr applied by the rider tends to remain substantially constant, whereas the speed of the control motor M1 continues to increase in order to maintain a comfortable pedalling speed, hence power of control motor M1 increases. At some point, which can be set by programming the controller C, the power PowerM1 of control motor M1 becomes sufficient to deliver the desired electrical assistance power to the bicycle, and no further assistance is required from the traction motor M2. Traction motor M2 may then be switched off (FIG. 5) in order to save electrical energy. The bicycle continues to move forwards, assisted by power from the rider and the ratio controlling motor M1, and consequently the traction gear 8 continues to rotate in a forward direction. However, a forward torque is no longer applied to the traction gear by traction motor M2, and consequently the second one-way clutch 12 unlocks, allowing the pinion gear 11 to rotate freely relative to the shaft of traction motor M2. Therefore, traction motor M2 is allowed to come to rest and it transmits no decelerating torque to the traction gear 8 or consequently to the wheel of the bicycle.

The locking device 17 continues to be not energised so that the second ring gear 16 is free to rotate, and no torque is transmitted through the planets to the supplementary sun gear 5b. However, due to still increasing speed of the reverse rotation of the first ring gear 4, the difference in speed between the supplementary sun gear 5b and the planetary carrier 2 is further increased. Therefore, the second ring gear 16 continues to rotate forwards but at a further decreasing speed.

The supplementary epicyclic subsystem consisting of the second sun gear 5b and the associated second set of planets 3b, may advantageously be set in order to achieve a desired speed ratio between associated components of the system.

Specifically, according to a preferred embodiment, as schematically shown in FIG. 1 the diameter of the second sun gear 5b is smaller than the diameter of the first sun gear 5a, and the diameter of the second set of planet gears 3b is larger than the diameter of the planets of the first set of planet gears 3a.

In this instance, when the second ring gear 16 is stationary, it is desirable that the ratio through the supplementary epicyclic subsystem should allow for a comfortable pedalling speed when the bicycle is travelling at the maximum legal assistance speed. For example, an overall gear ratio of 3.5 ensures a pedalling speed of approximately 60 rpm when the bicycle is travelling at the European maximum legal assisted speed of 25 km/h.

Therefore, as the bicycle approaches the maximum legal assisted speed, the locking device 17 continues to be not energised so that the second ring gear 16 is free to rotate, and no torque is transmitted through the planets to the second or supplementary sun gear 5b.

However, due to the chosen gear ratio of the supplementary epicyclic subsystem, the second ring gear 16 becomes stationary as the travelling speed of the bicycle reaches 25 km/h. This stopping of rotation of the second ring gear 16 may for example be assisted, in order to be smooth, by slightly adjusting the pedalling speed by controlling the speed of control motor M1, in order to create the appropriate relationship between the road speed of the bicycle and the speed of the pedals, to ensure that the second ring gear becomes completely stationary.

Once the travelling speed of the bicycle has exceeded the maximum legal assisted speed (typically 25 km/h) and the second ring gear 16 has completely stopped rotating, the controller C activates the locking device 17 to lock the angular position of the second ring gear 16, preventing it from rotating. For example, the electromagnetic device may comprise a solenoid energised by the controller C.

The engagement of the locking device 17 and the resulting locking of the second ring gear 16 creates a supplementary torque path through the system from the pedal shaft 1 to the chain gear 6 which provides a fixed overall gear ratio between the pedal shaft and the rear wheel of the bicycle. For example, a suitable gear ratio between the pedal shaft and the rear wheel of the bicycle may range between 1:3 and 1:4. A particularly comfortable gear ratio between the pedal shaft and the rear wheel of the bicycle is of approximately 1:3.5.

The main epicyclic system (the first sun gear Sa, the first set of planets 5a and the first outer ring 4) continues to rotate and electrical assistance may still be provided by motor M1, which provides torque to assist the first ring gear 4 rotating in the reverse direction. However, as the speed ratio between the pedals and the wheel is now fixed, the torque provided by the control motor M1 may now be progressively reduced in order to provide a smooth transition towards switching off the electrical assistance of the bicycle.

Once the road speed of the bicycle reaches the maximum legal assistance speed (FIG. 6), the control motor M1 may be switched off altogether. Hence, all electrical assistance has been removed from the e-Bike driveline system and the bicycle complies with the legislation.

The epicyclic gear system (particularly, the first sun gear 5a, the first set of planets 3a and the first ring gear 4) continue to rotate, however the one-way clutch 19 which connects the pinion gear 9 to the shaft S1 of control motor M1 disengages, because the control motor M1 is no longer applying torque through the clutch in a direction to assist the first ring gear 4 in turning in the reverse direction. Therefore, the control motor M1 is allowed to become stationary whilst the first ring gear 4 and the pinion 9 are allowed to continue rotating freely. Hence, the control motor M1 does not apply any regenerating or braking torque to the system. The bicycle is driven forwards solely by the power from the rider's pedalling action. Torque at the pedal shaft 1 is transferred through the planetary carrier 2 to the supplementary or second set of planet gears 3b, which apply an equal tangential force to the teeth of the supplementary second ring gear 16 and the supplementary or second sun gear 5b. The second ring gear 16 cannot turn due to engagement of the locking device 17, hence all of the rider's pedalling power is transferred to the second sun gear 5b, with a fixed speed ratio, and hence is transmitted via the chain ring 6 and chain 7 to the bicycle rear wheel.

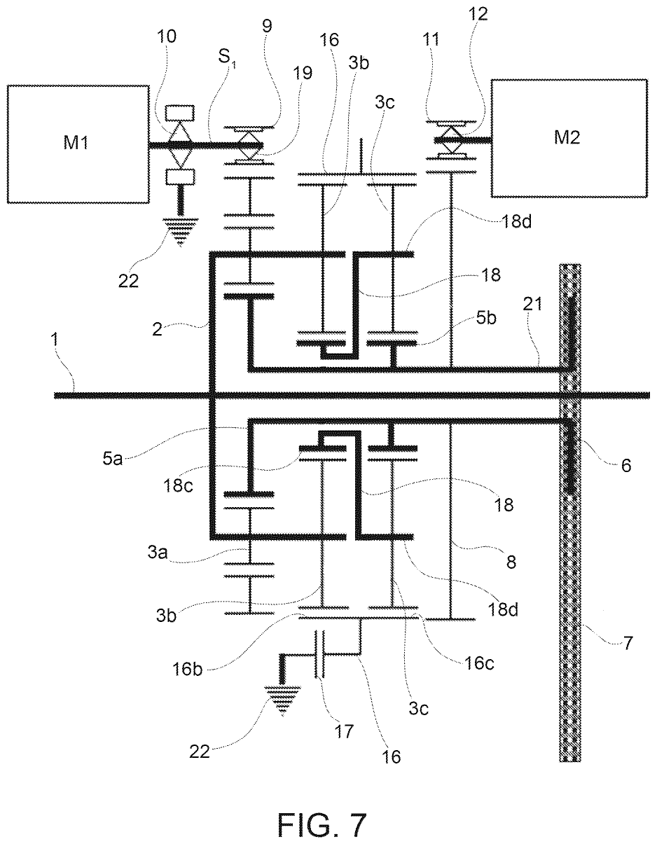

Referring to FIG. 7, a particularly compact alternative embodiment of the drive system is schematically depicted. The drive system of FIG. 7 provides a two-stage epicyclic gearing mechanism, which includes, in addition to the components disclosed in the embodiment of FIG. 1, an intermediate, supplementary epicyclic subsystem acting between the second set of planet gears 3b and the second sun gear 5b.

The supplementary epicyclic subsystem of FIG. 7 comprises a supplementary or intermediate planet carrier 18 and a third set of supplementary planet gears 3c.

The intermediate planet carrier 18 has a set of radially outwardly facing teeth schematically depicted at 18c on a smaller diameter, and carries the third set of supplementary planet gears 3c supported freely rotating on pins 18d located at a diameter larger than that of the teeth 18c.

The supplementary planet gears 3c mesh radially inwardly with the second sun gear 5b, and radially outwardly with an inner toothing 16c of the second ring gear 16.

The second ring gear 16 provides a pair of axially adjacent inward toothings, one 16b for meshing with the second set of planet gears 3b, and one 16c for meshing with the supplementary planet gears 3c.

According to the exemplary embodiment of FIG. 7, the supplementary planet gears 3c may be supported around the same axes and at the same radius as the planet gears 3a and/or 3b.

Optionally, according to alternative embodiments (not illustrated), the supplementary planet gears 3c may be mounted to the intermediate planet carrier 18 on mounting pins which are arranged at a different radius with respect to planet gears 3a and/or 3b. Hence there need not be a fixed relationship between the geometry of the epicyclic gear subsystem comprising components 3a, 4 and 5a, and the components of the epicyclic gear subsystem comprising components 3c, 5b and 16.

Hence, a similar overall ratio between the pedal and the wheel velocity may be achieved when the electrically operated locking device 17 is engaged and the second ring gear 16 is stationary but with a more favourable number of teeth on the second sun gear 5b and the second ring gear 16. For example, in order to achieve the required pedalling speed of 60 rpm at 25 km/h using the layout shown in FIG. 1, the second ring gear 16 typically has 98 teeth, the planet gears 3b of the second set may have 42 teeth and the second sun gear 5b may have 14 teeth. The second sun gear 5b may be too small in diameter for the pedal shaft 1 to pass through its centre. However, the alternative embodiment shown in FIG. 7 may provide a similar overall system ratio by using a second ring gear 16 having 76 teeth, a second set of planet gears 3b having 20 teeth and a set of supplementary planet gears having 16 teeth. The teeth 18c on the intermediate planet carrier may be 36 in number, and the second sun gear 5b may requires 44 teeth. Hence, the outside diameter of the second ring gear 16 may be reduced by more than 20%, and the diameter of the second and smaller second sun gear 5b may be increased by more than 150%.

It will be appreciated that the drive system of the present disclosure provides several advantages and benefits:

the epicyclic gear system allows the bicycle to be ridden at high speeds without any electrical assistance;
the epicyclic gear system allows all of the functions and advantages of a power assisted bicycle when the electrical assistance motor is switched on;
the system efficiency is optimised at higher road speed when the motors are both switched off because both the ratio control motor M1 and the traction motor M2 can be mechanically disconnected from the system when not required;
there is no necessity for either of the motors to regenerate any electrical energy. This leads to simplified motor control and electronic systems, and also a simplified battery management system which does not need to boost the motor voltage in order to recharge the battery.

1. An electric auxiliary drive system for a bicycle, comprising:
a pedal crankshaft for operation by a rider;
an output shaft for transmitting rotation to a rear wheel of the bicycle;
an epicyclic gearing mechanism configured to determine a transmission ratio between the pedal crankshaft and the output shaft;
an assist motor for driving the output shaft;
a control motor, drivingly connected to the epicyclic gearing mechanism for controlling, through the epicyclic gearing mechanism, the transmission ratio between the pedal crankshaft and the output shaft;
at least one first one-way clutch operatively connected between the control motor and a rigid element fixedly mountable to a bicycle frame, wherein the at least one first one-way clutch is configured for blocking a rotation of a first ring gear of the epicyclic gearing system mechanism in a first, forward direction of rotation and for releasing and allowing free rotation of said first ring gear of the epicyclic gearing mechanism in a second, reverse direction of rotation;
a second one-way clutch operatively connected between the assist motor and the output shaft, wherein the second one-way clutch is configured for drivingly connecting the assist motor to the output shaft when the assist motor is switched on to drive the output shaft in a forward direction, so as to assist in driving the bicycle forwards, and for disengaging the assist motor from the output shaft when the assist motor is switched off but the output shaft continues to rotate in the forward direction;
wherein the epicyclic gearing mechanism further comprises:
a second ring gear and an associated locking device fixedly mountable to the bicycle frame and operable to engage and block a rotation of the second ring gear;
a first sun gear and a second sun gear, both secured for rotation with the output shaft;
a first set of planet gears between the first sun gear and the first ring gear, and a second set of planet gears between the second sun gear and the second ring gear; and
a planet carrier which is secured for rotation with the pedal crankshaft and supporting the first and the second sets of planet gears;
and wherein the first and second sun gears, and the first and second sets of planet gears are configured to provide a desired transmission ratio between the pedal crankshaft and the output shaft for transmitting rotation to the rear wheel of the bicycle when the rotation of the second ring gear is locked by the locking device.

2. The electric auxiliary drive system of claim 1, wherein
the planet gears of the first set of planet gears have a diameter that is smaller than a diameter of the planet gears of the second set of planet gears, and wherein the first sun gear has a diameter that is larger than a diameter of the second sun gear.

3. The electric auxiliary drive system of claim 1, wherein said transmission ratio is set in a range between 1:3 and 1:4, whereby a single full turn of the pedal crankshaft corresponds to a number of turns of the rear wheel of the bicycle between 3 and 4 when the locking device locks the rotation of the second ring gear.

4. The electric auxiliary drive system of claim 3, wherein said transmission ratio is about 1:3.5, whereby a single full turn of the pedal crankshaft corresponds to 3.5 turns of the rear wheel of the bicycle when the locking device locks the rotation of the second ring gear.

5. The electric auxiliary drive system of claim 1, wherein the gears of the epicyclic gearing mechanism are so configured that the second ring gear stops rotating at a predetermined travelling speed of the bicycle, and that the second ring gear is locked in position by activating the locking device at travelling speeds of the bicycle exceeding said predetermined travelling speed.

6. The electric auxiliary drive system according to of claim 5, wherein said predetermined travelling speed of the bicycle is 25 km/h.

7. The electric auxiliary drive system of claim 1, further comprising an intermediate, supplementary epicyclic subsystem acting between the second set of planet gears and the second sun gear, the supplementary epicyclic subsystem comprising:
an intermediate planet carrier, and
a third set of supplementary planet gears supported freely rotating on pins arranged on the intermediate planet carrier along a given diameter,
wherein the intermediate planet carrier has a set of teeth arranged along a diameter that is smaller than a given diameter of the pins,
and wherein the supplementary planet gears mesh radially inwardly with the second sun gear, and radially outwardly with an inner toothing of the second ring gear.

8. The electric auxiliary drive system of claim 7, wherein the second ring gear provides a pair of axially adjacent inner toothings, one for meshing with the second set of planet gears, and the other one for meshing with the supplementary planet gears.

9. An electrically powered bicycle comprising the electric auxiliary drive system of claim 1.
